(19) United States
(12) Patent Application Publication
(10) Pub. No.: US 2025/0030150 A1
(43) Pub. Date: Jan. 23, 2025

(54) ANTENNA FOR MOBILE TERMINAL, AND MOBILE TERMINAL

(71) Applicant: KUNSHAN INNOWAVE COMMUNICATION TECHNOLOGY CO., LTD., Kunshan City (CN)

(72) Inventor: Xudong ZHANG, Kunshan City (CN)

(73) Assignee: KUNSHAN INNOWAVE COMMUNICATION TECHNOLOGY CO., LTD., Kunshan City, JS (CN)

(21) Appl. No.: 18/281,863

(22) PCT Filed: Nov. 28, 2022
(86) PCT No.: PCT/CN2022/134761

§ 371 Date: Sep. 13, 2023

(30) Foreign Application Priority Data
Sep. 8, 2022 (CN) 202211095726.9
Sep. 8, 2022 (CN) 202222387847.2

(51) Int. Cl. H01Q 1/24; H01Q 1/38; H01Q 1/50; H01Q 9/04

(52) U.S. Cl. CPC H01Q 1/243; H01Q 1/38; H01Q 1/50; H01Q 9/045

(57) ABSTRACT

An antenna for a mobile terminal and a mobile terminal are provided. The antenna for a mobile terminal includes: a first radiation unit, a second radiation unit, a coupling unit and a chip unit that are arranged on a mainboard. A terminal of the first radiation unit is provided with a feeding point. The feeding point is connected to the chip unit. Another terminal of the first radiation unit is non-electrically connected to a terminal of the second radiation unit through the coupling unit, and another terminal of the second radiation unit is grounded.

The present disclosure claims priorities to Chinese Patent Application No. 202211095726.9, titled “ANTENNA FOR MOBILE TERMINAL, AND MOBILE TERMINAL”, filed on Sep. 8, 2022 with the China National Intellectual Property Administration, and Chinese Patent Application 202222387847.2, titled “ANTENNA FOR MOBILE TERMINAL, AND MOBILE TERMINAL”, filed on Sep. 8, 2022 with the China National Intellectual Property Administration, both of which are incorporated herein by reference in their entireties.

### FIELD

The present disclosure relates to the technical field of mobile terminals, and in particular to an antenna for a mobile terminal and a mobile terminal.

### BACKGROUND

Antennas are the front-end components for mobile terminals to transmit and receive wireless signals. In transmitting, an antenna effectively converts a high-frequency current in a circuit or a guided wave on a feed transmission line to a polarized spatial electromagnetic wave, and then emits the spatial electromagnetic wave in a predetermined direction. In receiving, a reverse transformation is performed.

At present, many antennas for mobile terminals serve as radiators, and further serve as capacitive sensors to sense a distance between a human body and a mobile terminal. When the distance between the human body and the mobile terminal is less than a set value, the mobile terminal reduces a transmission power to reduce SAR (specific absorption rate), thereby reducing antenna radiation to the human body. SAR is an internationally defined standard for measuring safety of electromagnetic radiation, and refers to an absorption ratio of a human body to electromagnetic radiation. A smaller SAR indicates less damage to the human body, and a greater SAR indicates greater damage to the human body. The unit of SAR is mW/g. Currently, there are two standards for SAR, a CE standard (European standard) and an FCC standard (American standard). The CE standard is 2 mW/g, and the FCC standard is 1.6 mW/g.

SAR is closely related to a radiant power of an antenna, a radiation direction of the antenna, and a distance between a human body and the antenna. When the user uses a mobile terminal of a wireless device, the user holds the mobile terminal in hands or places the mobile terminal on a body part. The closer the human body is to the antenna of the device, the SAR is higher; and the farther the human body is away from the antenna of the device, the SAR is lower. Therefore, it is required for the designers to ensure that SAR meets standard requirements when the user contacts with the antenna. Generally, a greater radiant power of an antenna indicates a greater SAR, and a smaller radiant power of the antenna indicates a smaller SAR. In designing antennas, in order to control radiation performances of antennas to meet a standard, it is required to balance SAR and antenna performance to obtain a state with low SAR and good antenna performance.

In a case that an antenna serves as a capacitive sensor for SAR, a grounded part of the antenna is connected to a capacitor and then is grounded, resulting in the capacitor affecting the performance of the antenna and an increase in costs.

### SUMMARY

In order to solve the above problems, an antenna for a mobile terminal and a mobile terminal are provided according to the embodiments of the present disclosure.

In a first aspect, an antenna for a mobile terminal is provided according to an embodiment of the present disclosure. The antenna includes: a first radiation unit, a second radiation unit, a coupling unit, and a chip unit. The first radiation unit, the second radiation unit, the coupling unit, and the chip unit are arranged on a mainboard. A terminal of the first radiation unit is provided with a feeding point. The feeding point is connected to the chip unit. Another terminal of the first radiation unit is non-electrically connected to a terminal of the second radiation unit through the coupling unit. Another terminal of the second radiation unit is grounded.

In a second aspect, a mobile terminal is provided according to an embodiment of the present disclosure. The mobile terminal includes the antenna for a mobile terminal.

In the antenna for a mobile terminal and the mobile terminal according to the embodiments of the present disclosure, a coupling unit having an intersection structure, such as a helical structure, with an internal non-electrically connection is adopted, and no capacitor is used between the second radiation unit and a grounding point, thereby saving the costs and avoiding an impact on performance of the antenna by an introduced capacitor.

In order to make the objectives, the features and the advantages of the present disclosure obvious and understandable, preferred embodiments are provided below, and the embodiments are described in detail in conjunction with the drawings.

### BRIEF DESCRIPTION OF THE DRAWINGS

In order to more clearly describe the technical solutions in the embodiments of the present disclosure or the technical solutions in the conventional technology, drawings to be used in the description of the embodiments of the present disclosure or the conventional technology are briefly described hereinafter. It is apparent that the drawings described below are merely used for describing the embodiments of the present disclosure, and those skilled in the art may obtain other drawings according to the provided drawings without any creative effort.

FIG. 1 shows a circuit diagram of an antenna for a mobile terminal according to the conventional technology;

FIG. 2 shows a schematic structural diagram of an antenna for a mobile terminal according to the conventional technology;

FIG. 3 shows a circuit diagram of an antenna for a mobile terminal according to a first embodiment of the present disclosure;

FIG. 4 shows a circuit diagram of an antenna for a mobile terminal according to a second embodiment of the present disclosure;

FIG. 5 shows a schematic structural diagram of an antenna for a mobile terminal according to an embodiment of the present disclosure;

FIG. 6 shows a schematic structural diagram of a coupling unit of an antenna for a mobile terminal according to a first embodiment of the present disclosure;

FIG. 7 shows a schematic structural diagram of a coupling unit of an antenna for a mobile terminal according to a second embodiment of the present disclosure;

FIG. 8 shows a schematic structural diagram of a coupling unit of an antenna for a mobile terminal according to a third embodiment of the present disclosure;

FIG. 9 shows a schematic structural diagram of a coupling unit of an antenna for a mobile terminal according to a fourth embodiment of the present disclosure;

FIG. 10 shows a schematic diagram of a comparison between an S11 simulation in an embodiment shown in FIG. 1 and an S11 simulation in an embodiment shown in FIG. 3;

FIG. 11 shows a schematic diagram of a comparison between an efficiency simulation in an embodiment shown in FIG. 1 and an efficiency simulation in an embodiment shown in FIG. 3; and

FIG. 12 shows a schematic structural diagram of a mobile terminal according to an embodiment of the present disclosure.

Reference numerals are listed as follows:

| | | | |
|---|---|---|---|
| 1 | feeding point | 2 | radiation unit |
| 3 | mainboard | 4 | first radiation unit |
| 5 | second radiation unit | 6 | coupling unit |
| 7 | SAR control chip | 8 | radio frequency chip |
| 9 | impedance adjustment unit | 10 | speaker |
| 11 | USB interface | 12 | motor |
| 13 | antenna body | 14 | left coupling part |
| 15 | right coupling part | 16 | coupling branch |
| 17 | matching unit | | |

### DETAILED DESCRIPTION OF EMBODIMENTS

In the description of the present disclosure, it should be understood that the orientation or positional relationships indicated by terms “center”, “longitudinal”, “lateral”, “length”, “width”, “thickness”, “up”, “down”, “front”, “rear”, “left”, “right”, “vertical”, “horizontal”, “top”, “bottom”, “inner”, “outer”, “clockwise”, “anticlockwise” and the like are based on the orientation or positional relationships shown in the drawings, and are merely for the convenience of describing the present disclosure and the simplification of the description, and do not indicate or imply that the device or element referred to must be in a particular orientation, or be constructed and operated in a particular orientation, and therefore should not be construed as a limitation to the present disclosure.

In addition, the terms “first”, “second” and the like are for purpose of description, and should not be construed as indicating or implying relative importance or implying the number of the indicated technical features. Therefore, the features defined by “first” and “second” may explicitly or implicitly include one or more of the features. In the description, unless otherwise limited, the term “multiple” means two or more.

In present disclosure, terms such as “installation”, “link”, “connection” and “fix” should be understood broadly, unless otherwise specifically defined. For example, it may be a fixed connection, a detachable connection, or an integral connection; it may be a mechanical connection or an electrical connection; and it may be a direct connection, an indirect connection through an intermediate medium, or an internal connection between two components. Those skilled in the art should understand specific meanings of the above terms in the present disclosure based on specific situations.

For multiple-input multiple-output (MIMO), each of a signal transmitter and a signal receiver includes multiple radiation units. In a case that the radiation units are arranged with a large space distance, the correlation between the radiation units is weak. In mobile terminals such as mobile phones, radiation units cannot operate independently due to the small space, and strong electromagnetic coupling is generated between the radiation units.

For coupling, in a case that two or more radiation units arranged in a free space, a radiation unit is affected by an electromagnetic effect generated by a current of the radiation unit itself, and is affected by electromagnetic effects generated by currents of other radiation units. Especially, in a case that the radiation units are arranged close to each other, complex interactions are generated between the radiation units, which are referred to as mutual coupling.

Isolation refers to a degree to which radiation units are independent from each other. A smaller coupling between radiation units indicates a greater isolation between the radiation units, and a greater coupling between radiation units indicates a smaller isolation between the radiation units. For example, in practices, an isolation of 15 dB can meet engineering requirements.

For pattern diversity, powers radiated by the radiation units are unevenly distributed in different directions of a space, that is, an antenna has directionality. A pattern is a graph showing a function relationship between radiation features of an antenna and space coordinates, and is a manner in which the directionality of the antenna is graphically described. Therefore, radiation features of radiation units may be analyzed based on pattern diversity.

For polarization diversity, two signals from a same source are carried by radio waves with different polarization directions, such as a vertical polarization and a horizontal polarization, of a radiation unit. These two signals are independent and uncorrelated from each other, and have different attenuation features, achieving an effect of polarization diversity.

A microstrip is a microwave transmission line formed by a single conductor strip, and is applicable to manufacturing a planar transmission line of a microwave integrated circuit. The microstrip has a small volume, a light weight, a wide usage frequency bandwidth, high reliability, a low manufacturing cost, a high conductivity, and good stability.

A throughput is an amount of signals that can be transmitted by a communication system per unit time/bandwidth. Since a communication system performs signal transmission, throughput is one of most important indicators for measuring the communication system.

A Q value of an antenna is a ratio of energy storage to energy consumption of the antenna near a resonance point, and indicates a sensitivity of a resonance feature of the antenna to frequency. A greater Q value indicates a higher sensitivity of the resonance of the antenna to frequency, and a narrower bandwidth of a reflection coefficient.

At present, in designing a mobile terminal, it is required to consider the transmission and reception performance (TRP and TIS) of the antenna of the mobile terminal and the radiant power of the mobile terminal to the human body. A greater radiant power may cause damage to human body. Therefore, there is an important test indicator SAR for the antenna of the mobile terminal, which indicates the radiation of the mobile terminals to the human body.

According to the conventional technology, SAR of a mobile terminal may be changed by adjusting wiring of an antenna. However, due to the requirement of measuring SAR of the human body, the requirement cannot be met by adjusting the wiring of the antenna. In a most direct way, a transmission power of a mobile phone may be reduced, so that the transmission performance of the antenna and the SAR are reduced. However, in this way, the transmission performance of the mobile terminal cannot meet a standard.

According to the conventional solution, a SAR control chip is added to use the antenna as a sensor. When a distance between the mobile terminal and the human body exceeds a safe distance, the transmission power of the mobile terminal is reduced, so that the antenna of the mobile terminal does not cause damage to the human body. When the distance between the mobile terminal and the human body does not exceed the safe distance, the transmission power of the mobile terminal is maintained unchanged. In the above process, the antenna of the mobile terminal serves as a transmitting antenna and as a sensor for detecting a distance. Therefore, it is required for the antenna of the mobile terminal to be connected to two branches, that is, an antenna branch and a capacitive sensor branch, inevitably resulting in conflicts.

The signal transmitted by the antenna of the mobile terminal is a high-frequency signal, and the signal of the sensor is a low-frequency signal. The high-frequency signal and the low-frequency signal may be separated by using an inductor and a capacitor, so that the high-frequency signal and the low-frequency signal do not interfere with each other.

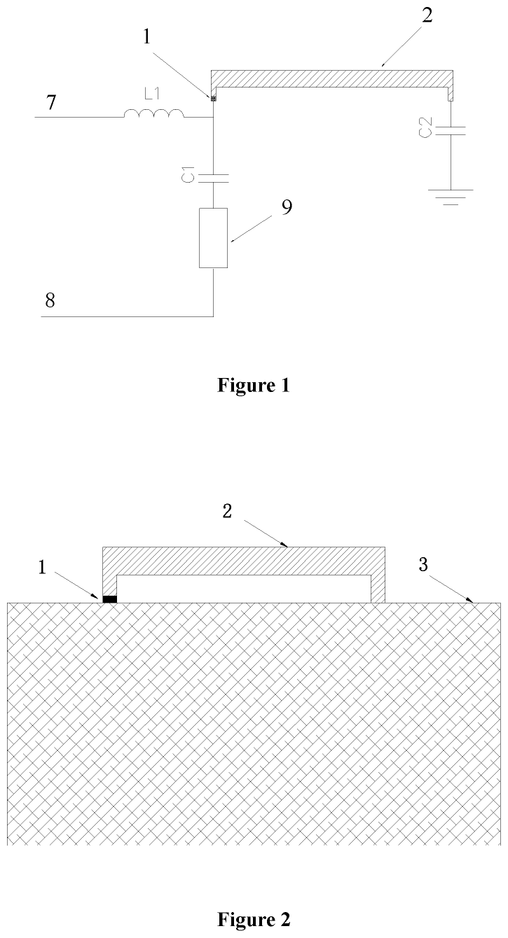

As shown in FIG. 1 and FIG. 2, a terminal of a feeding point 1 is connected to a terminal of a radiation unit 2. The radiation unit 2 is arranged on a mainboard 3. Another terminal of the radiation unit 2 is grounded through a capacitor C2. Another terminal of the feeding point 1 is connected to a SAR control chip 7 through an inductor L1 and is connected to a radio frequency chip 8 through a series circuit including a capacitor C1 and an antenna matching unit 9.

The antenna matching unit 9 adopts a series-parallel combination of an inductor and a capacitor. The antenna matching unit 9 is configured to adjust an impedance of the antenna to reduce reflection of a signal at an input terminal of the antenna, allowing more signals to enter the antenna.

In the conventional technology shown in FIG. 1, L1 represents an inductor with a large inductance, and L1>100 nH. For a high-frequency antenna, the inductor is equivalent to an open circuit and has little impact on the performance of the antenna, and the inductor is arranged to isolate an impact of the SAR control chip 7 on the antenna. For the low-frequency SAR control chip 7, the inductor is equivalent to a short circuit.

In the conventional technology shown in FIG. 1, C1 represents a capacitor with a large capacitance, and C1>20 pF. The capacitor is equivalent to a short circuit for the branch on which the antenna radio frequency chip 8 of the antenna is arranged, and has little impact. The capacitor is equivalent to an open circuit for the branch on which the SAR control chip 7 is arranged to isolate the impact of radio frequency signals on the SAR control chip 7.

In the conventional technology shown in FIG. 1, C2 represents a capacitor with a large capacitance, and C2>20 pF. The antenna should be grounded. However, the antenna being grounded is equivalent to the SAR control chip 7 being grounded, resulting in that the SAR control chip 7 is ineffectively arranged. Therefore, the capacitor C2 is used. The capacitor C2 may have the following effects on the performance of the antenna.
(1) The capacitor C2, as a passive device, has an insertion loss and consumes energy.
(2) The capacitor C2 is connecting to a terminal of the antenna, affecting the impedance of the antenna and not conducive to debugging the antenna.

In the technical solution of the antenna of the mobile terminal according to the conventional technology shown in FIG. 1, the radiation unit 2 of the antenna is a complete metal patch without being divided.

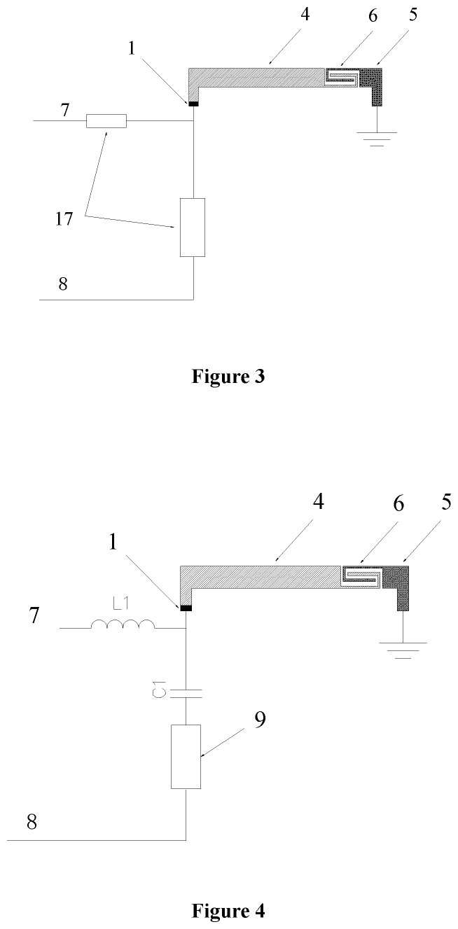

As shown in FIG. 3, in an embodiment of the present disclosure, an antenna for a mobile terminal includes a first radiation unit 4, a second radiation unit 5, a coupling unit 6, and a chip unit that are all arranged on a mainboard 2. A terminal of the first radiation unit 4 is provided with a feeding point. The feeding point 1 is connected to the chip unit. Another terminal of the first radiation unit 4 is non-electrically connected to a terminal of the second radiation unit 5 through the coupling unit 6. Another terminal of the second radiation unit 5 is grounded.

In the embodiment of the present disclosure, the coupling unit 6 is introduced without using a capacitor at the grounding point of the antenna, and the second radiation unit 5 is directly grounded. At the end of the antenna, coupling processing is performed by the coupling unit 6, and then energy is transmitted to the grounding point through the second radiation unit 5. The first radiation unit 4 is not directly physically connected to the second radiation unit 5. For a sensor signal of the chip unit, the first radiation unit 4 and the second radiation unit 5 are disconnected from each other, and the first radiation unit 4 is not connected to the grounding point. Preferably, the antenna for a mobile terminal according to an embodiment of the present disclosure further includes a matching unit 17. The chip unit includes a SAR control chip 7 and a radio frequency chip 8. The feeding point 1 is electrically connected to the chip unit through the matching unit 17. That is, the first radiation unit 4 is not physically connected to the second radiation unit 5. For a sensor signal of the SAR control chip 7 in the chip unit, the first radiation unit 4 and the second radiation unit 5 are disconnected from each other.

Specifically, as a sensor, the antenna generates a capacitive effect when the antenna approaches the human body. The capacitive effect is transmitted to the SAR control chip 7, and the SAR control chip 7 determines a distance between the antenna and the human body based on the transmitted inductive capacitance.

In the embodiment shown in FIG. 3, no capacitor is arranged between the second radiation unit 5 and the grounding point, saving costs and avoiding impact of a capacitor on the performance of the antenna. The impact may refer to the above descriptions.

As shown in FIG. 3, in the embodiment of the present disclosure, a coupling unit 6 is arranged to divide the antenna of the mobile terminal to two disconnected parts: the first radiation unit 4 and the second radiation unit 5. The first radiation unit 4 and the second radiation unit 5 are arranged on the mainboard 3. A terminal of the first radiation unit 4 is connected to a terminal of the second radiation unit 5 through the coupling unit 6. Another terminal of the second radiation unit 5 is grounded. Another terminal of the first radiation unit 4 is connected to a feeding point 1. The feeding point 1 is connected to the chip unit.

In the embodiment of the present disclosure, the matching unit 17 includes the inductor L1, the capacitor C1, and the impedance adjustment unit 9. The feeding point 1 is connected to the SAR control chip 7 and the radio frequency chip 8. Feeding point 1 is connected to the SAR control chip 7 through the inductor L1. The feeding point 1 is connected to the radio frequency chip 8 through the capacitor C1 and the impedance adjustment unit 9. In an embodiment, the feeding point 1 is connected to the radio frequency chip 8 through a series branch formed by the capacitor C1 and the impedance adjustment unit 9. Apparently, the capacitor C1 and the impedance adjustment unit 9 may be connected in other ways, as long as the feeding point 1 is connected to the radio frequency chip 8. The ways are not limited herein.

The mainboard 3 is a conventional PCB (printed circuit board).

The impedance adjustment unit 9 is formed by a series-parallel combination of an inductor and a capacitor. The impedance adjustment unit 9 is configured to adjust the impedance of the antenna to reduce reflection of a signal at an input terminal of the antenna, so that more signals may be allowed to enter the antenna.

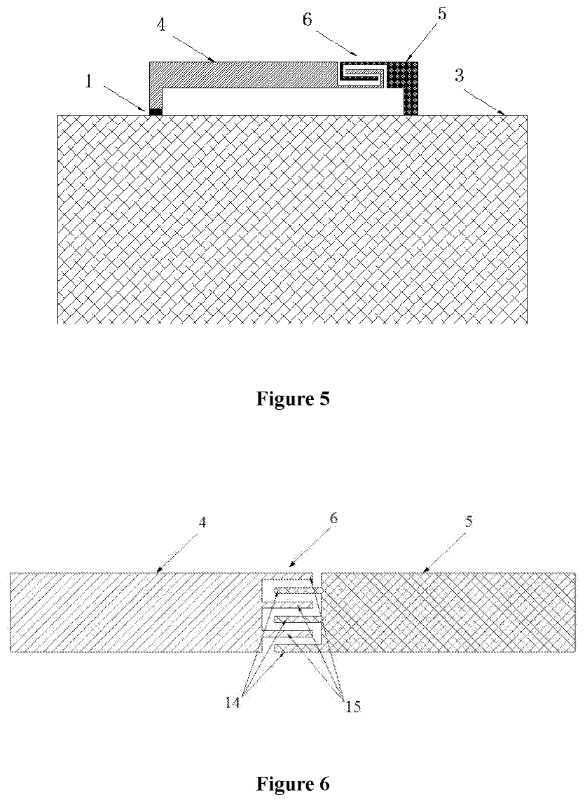

In the embodiments of the present disclosure shown in FIGS. 4 and 5, an inductor L1 and a SAR control chip 7 form a capacitive sensor branch. A capacitor C1, an impedance adjustment unit 9, and a radio frequency chip 8 form an antenna branch. The two branches are connected to a feeding point 1.

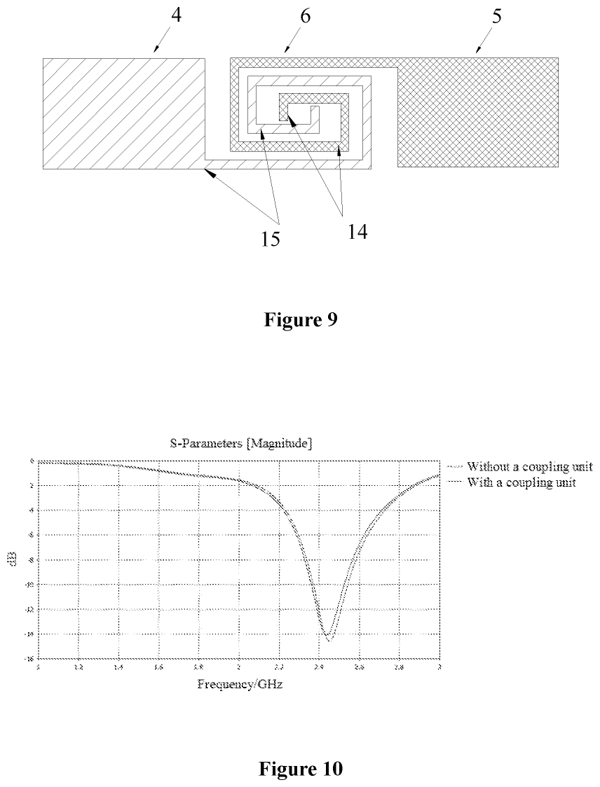

As shown in FIG. 6 to FIG. 9, a coupling unit 6 includes a left coupling part 14 and a right coupling part 15. The left coupling part 14 is connected to a terminal of the second radiation unit 5. The right coupling part 15 is connected to another terminal of the first radiation unit 4. The left coupling part 14 and the right coupling part 15 intersect with each other with a non-electrically connection gap.

Specifically, a gap is arranged between the left coupling part 14 and the right coupling part 15, and the left coupling part 14 and the right coupling part 15 are not physically connected to each other directly. A width of the gap may be configured according to actual requirements, and the width of the gap may be a width of a gap at any position between the left coupling part 14 and the right coupling part 15.

The width of the gap ranges from 0.2 mm to 1.2 mm. A greater width of the gap indicates a weaker coupling, and a smaller width of the gap indicates a stronger coupling. In practice, the width of the gap is adjusted according to requirements for coupling.

Specifically, the coupling unit has an intersection structure including two separate radiation units non-electrically connected to each other, where the left coupling part 14 is one radiation unit, and the right coupling part 15 is the other radiation unit. For the intersection structure shown in FIG. 6 to FIG. 9, in a case that the antenna transmits a high-frequency signal, due to that the gap is arranged between the left coupling part 14 and the right coupling part 15 and the two radiation units intersect with each other, the high-frequency signal may be transmitted from the first radiation unit 4 to the second radiation unit 5 by coupling. More intersect sections of the coupling unit 6 indicate more amount of coupling. However, in a case that the antenna serves as a capacitive sensor, a low-frequency signal is used by the capacitive sensor. In a low-frequency state, the first radiation unit 4 and the second radiation unit 5 are not coupled. Thus, it may be considered that the first radiation unit 4 and the second radiation unit 5 are disconnected from each other in a low-frequency state. Therefore, the coupling unit 6 performs the function of blocking low-frequency signals and conducting high-frequency signals.

With the antenna for a mobile terminal according to the embodiments of the present disclosure, no additional capacitor (such as C2) is arranged to affect the performance of the antenna, the costs are reduced, and the antenna can be used as a capacitive sensor.

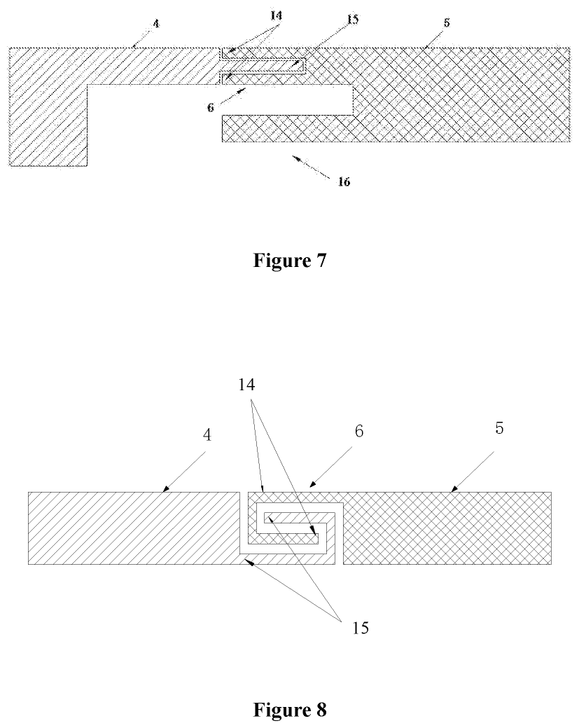

As shown in FIG. 7, the coupling unit further includes a coupling branch 16 for increasing a radiation area of the antenna. In an embodiment, the coupling branch 16 may be configured as a U-shape branch. The coupling branch 16 may be further be configured as other shapes according to actual situations of the antenna, which is no limited herein.

As shown in FIG. 6, a structure of a coupling unit of an antenna for a mobile terminal according to a first embodiment of the present disclosure is provided. The first radiation unit 4 and the second radiation unit 5 are connected to each other through the right coupling part 15 and the left coupling part 14 of the coupling unit 6.

The right coupling part 15 and the left coupling part 14 of the coupling unit 6 have serrated structures. The first radiation unit 4 and the second radiation unit 5 are connected to each other through the serrated structures. Energy may be transferred from the first radiation unit 4 to the second radiation unit 5 through the coupling unit 6, and part of the energy may be lost due to the gap between the first radiation unit 4 and the second radiation unit 5.

Specifically, a terminal of the first radiation unit 4 is connected to the right coupling part 15, and a terminal of the second radiation unit 5 is connected to the left coupling part 14. The right coupling part 15 connected to the terminal of the first radiation unit 4 has a serrated structure, and the left coupling part 14 connected to the terminal of the second radiation unit 5 also has a serrated structure. The right coupling part 15 and the left coupling part 14 intersect with each other to form the coupling unit 6. A terminal of the first radiation unit 4 and a terminal of the second radiation unit 5 are respectively connected to a feeding point 1 and a grounding point to form a loop antenna.

Preferably, in the embodiment of the present disclosure shown in FIG. 6, the serrated structures are generally arranged with equal space intervals. That is, each two adjacent serrations in the serrated structures have an equal distance. The distance between adjacent serrations generally ranges from 0.3 mm to 1 mm, and the distance may be adjusted according to the actual situations. The serrations in the serrated structures are generally configured to be in regular shapes, for example, in rectangle shapes, in triangle shapes, or in square shapes.

In a case that the antenna transmits a high-frequency signal, the first radiation unit 4 and the second radiation unit 5 intersect with each other, and the high-frequency signal may be transmitted from the first radiation unit 4 to the second radiation unit 5 through coupling. More intersect sections of the intersection structures of the coupling unit 6 indicate more amount of coupling of the antenna. In a case that the antenna transmits a low-frequency signal, the coupling unit 6 serves as a capacitor. That is, in a case that the antenna serves as a capacitive sensor, a low-frequency signal is used by the capacitive sensor. In a low-frequency state, the first radiation unit 4 and the second radiation unit 5 are not coupled. Thus, it may be considered that the first radiation unit 4 and the second radiation unit 5 are disconnected from each other in a low-frequency state. Therefore, the coupling unit 6 performs the function of blocking low-frequency signals and conducting high-frequency signals.

As shown in FIG. 7, a structure of a coupling unit of an antenna for a mobile terminal according to a second embodiment of the present disclosure is provided. The first radiation unit 4 and the second radiation unit 5 are connected to each other through the right coupling part 15 and the left coupling part 14 of the coupling unit 6.

The left coupling part 14 and the right coupling part 15 have mutually adapted concave-convex structures. In a case that the left coupling part 14 is configured to have a “ [symbol] ”-shape structure, the right coupling part 15 is configured to have a “ [symbol] ”-shape structure. In a case that the left coupling part 14 is configured to have a “ [symbol] ”-shape structure, the right coupling part 15 is configured to have a “ [symbol] ”-shape structure.

The first radiation unit 4 and the second radiation unit 5 are connected to each other through the mutually adapted concave-convex structures. Energy may be transferred from the first radiation unit 4 to the second radiation unit 5 through the coupling unit 6, and part of the energy may be lost due to the gap between the first radiation unit 4 and the second radiation unit 5.

As shown in FIG. 8, a structure of a coupling unit of an antenna for a mobile terminal according to a third embodiment of the present disclosure is provided. The first radiation unit 4 and the second radiation unit 5 are connected to each other through the right coupling part 15 and the left coupling part 14 of the coupling unit 6.

The left coupling part 14 and the right coupling part 15 have U-shape structures with openings opposite each other. The first radiation unit 4 and the second radiation unit 5 are connected to each other through the U-shape structures with openings opposite each other. Energy may be transferred from the first radiation unit 4 to the second radiation unit 5 through the coupling unit 6, and part of the energy may be lost due to the gap between the first radiation unit 4 and the second radiation unit 5.

As shown in FIG. 8, a structure of a coupling unit of an antenna for a mobile terminal according to a fourth embodiment of the present disclosure is provided. The first radiation unit 4 and the second radiation unit 5 are connected to each other through the right coupling part 15 and the left coupling part 14 of the coupling unit 6.

The left coupling part 14 and the right coupling part 15 have helical structures. The first radiation unit 4 and the second radiation unit 5 are connected to each other through the helical structures. Energy may be transferred from the first radiation unit 4 to the second radiation unit 5 through the coupling unit 6, and part of the energy may be lost due to the gap between the first radiation unit 4 and the second radiation unit 5.

Specifically, a terminal of the first radiation unit 4 is connected to the right coupling part 15, and a terminal of the second radiation unit 5 is connected to the left coupling part 14. The right coupling part 15 connected to the terminal of the first radiation unit 4 has a helical structure, and the left coupling part 14 connected to the terminal of the second radiation unit 5 also has a helical structure. The right coupling part 15 and the left coupling part 14 intersect with each other to form the coupling unit 6. A terminal of the first radiation unit 4 and a terminal of the second radiation unit 5 are respectively connected to a feeding point 1 and a grounding point to form a loop antenna.

In a case that the antenna transmits a high-frequency signal, the first radiation unit 4 and the second radiation unit 5 intersect with each other, and the high-frequency signal may be transmitted from the first radiation unit 4 to the second radiation unit 5 through coupling. Many intersect sections of the helical structures of the coupling unit 6 indicate more amount of coupling of the antenna. In a case that the antenna transmits a low-frequency signal, the coupling unit 6 serves as a capacitor. That is, in a case that the antenna serves as a capacitive sensor, a low-frequency signal is used by the capacitive sensor. In a low-frequency state, the first radiation unit 4 and the second radiation unit 5 are not coupled. Thus, it may be considered that the first radiation unit 4 and the second radiation unit 5 are disconnected from each other in a low-frequency state. Therefore, the coupling unit 6 performs the function of blocking low-frequency signals and conducting high-frequency signals.

It should be noted that the shapes, sizes, lengths, materials and the like of the radiation unit 2, the first radiation unit 4, and the second radiation unit 5 in the embodiments of the present disclosure may be configured according to actual requirements, and are not limited herein in the embodiments of the present disclosure.

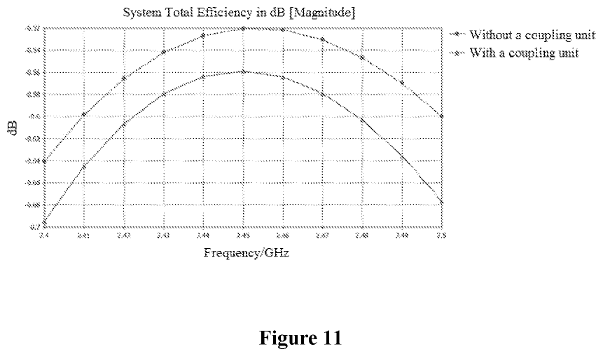

From the simulation results shown in FIG. 10 and FIG. 11, it can be seen that there is little difference between the performance of the antenna adopting a coupling unit in the embodiment shown in FIG. 3 and the performance of the antenna not adopting a coupling unit in the embodiment shown in FIG. 1. However, with the antenna adopting the coupling unit, the main radiation unit of the antenna is not grounded, effectively overcoming the impact of an introduced capacitor on the performance of the antenna.

The impact of the introduced capacitor on the performance of the antenna includes but is not limited to the following.
(1) The introduced capacitor, as a passive device, has an insertion loss and consumes energy.
(2) Connecting the introduced capacitor to an end of the antenna affects the impedance of the antenna, which is not conducive to debug the antenna.

In an embodiment, the first radiation unit 4, the second radiation unit 5 and the coupling unit 6 form a loop antenna or an IFA antenna.

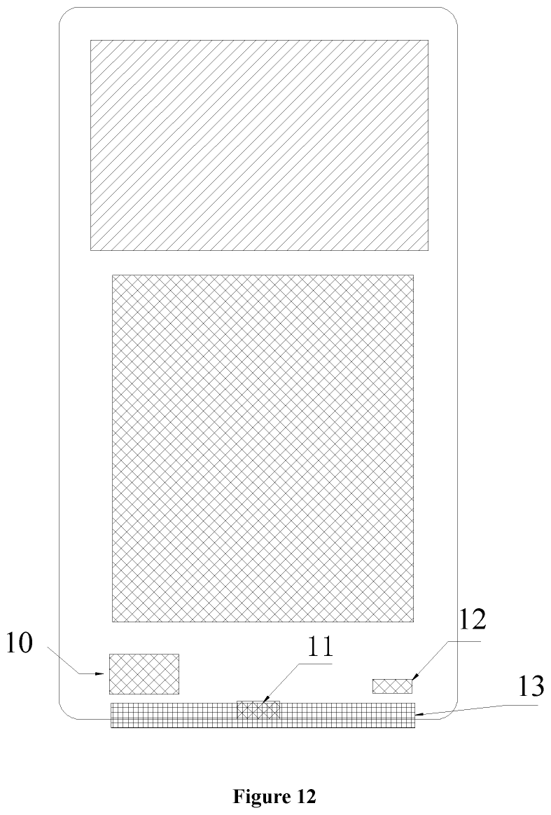

As shown in FIG. 12, a mobile terminal according to an embodiment of the present disclosure includes components such as a speaker 10, a USB (universal serial bus) interface 11, a motor 12, and an antenna 13.

In the embodiment of the present disclosure shown in FIG. 12, the antenna 13 of the mobile terminal is arranged in a clearance region of a PCB mainboard 3, thereby reducing the impact of devices such as the USB interface 11, the motor 12, and a microphone on the performance of the antenna. The clearance region of the PCB refers to a region where no other device is arranged.

The antenna for a mobile terminal according to the embodiments of the present disclosure is applicable to various mobile terminals, and includes communication antennas operating in a 2G/3G/4G/5G frequency band for devices such as mobile phones and laptops, GPS/BT/WiFi antennas, and the like. Furthermore, the antenna for a mobile terminal according to the embodiments of the present disclosure operates in a frequency band ranging from 1710 MHz to 2690 MHz, covering frequency bands such as GSM1800/1900, WCDMA Band 1/2/3/4, and LTE Band 1/2/3/4/7/38/39/40/41. The mainboard 3 is a flexible printed circuit (FPC) mounted on an antenna bracket, or made by performing a process such as LDS (laser direct structuring).

Some mobile terminals, such as mobile phones, may use metal frames as antennas. A feeding point of the antenna of the mobile phone is connected to a radio frequency terminal of the mainboard of the mobile phone through a coaxial cable. A signal of the antenna, serving as a sensor, is transmitted to a SAR control chip on the mainboard through a flat cable of the mobile phone.

The above embodiments are only some of the embodiments of the present disclosure, and the scope of the present disclosure is not limited thereto. Modifications or substitutions conceived by those skilled in the art within the technical scope disclosed in this specification fall within the scope of the present disclosure. Therefore, the protection scope of the present disclosure should conform to the protection scope of the claims.

1. An antenna for a mobile terminal, comprising: a first radiation unit, a second radiation unit, a coupling unit, and a chip unit, wherein:
the first radiation unit, the second radiation unit, the coupling unit, and the chip unit are arranged on a mainboard, a terminal of the first radiation unit is provided with a feeding point, the feeding point is connected to the chip unit, another terminal of the first radiation unit is non-electrically connected to a terminal of the second radiation unit through the coupling unit, and another terminal of the second radiation unit is grounded.

2. The antenna according to claim 1, wherein the coupling unit comprises a left coupling part and a right coupling part, the left coupling part is connected to a terminal of the second radiation unit, the right coupling part is connected to a terminal of the first radiation unit, and the left coupling part and the right coupling part intersect with each other with a non-electrically connection gap.

3. The antenna according to claim 2, wherein the coupling unit further comprises a coupling branch for increasing a radiation area of the antenna.

4. The antenna according to claim 2, wherein the left coupling part and the right coupling part are configured to have mutually adapted concave-convex structures, and the first radiation unit and the second radiation unit are connected to each other through the mutually adapted concave-convex structures.

5. The antenna according to claim 2, wherein the left coupling part and the right coupling part are configured to have serrated structures, and the first radiation unit and the second radiation unit are connected to each other through the serrated structures.

6. The antenna according to claim 5, wherein the serrated structures are arranged with equal space distances, and a distance between adjacent serrations of each of the serrated structures ranges from 0.3 mm to 1 mm.

7. The antenna according to claim 2, wherein the left coupling part and the right coupling part are configured to have U-shape structures with openings opposite each other, and the first radiation unit and the second radiation unit are connected to each other through the U-shape structures with openings opposite each other.

8. The antenna according to claim 2, wherein the left coupling part and the right coupling part are configured to have helical structures, and the first radiation unit and the second radiation unit are connected to each other through the helical structures.

9. The antenna according to claim 1, wherein the first radiation unit, the second radiation unit and the coupling unit form a loop antenna or an IFA antenna.

10. The antenna according to claim 1, further comprising a matching unit, wherein the chip unit comprises an SAR control chip and a radio frequency chip, and the feeding point is electrically connected to the chip unit through the matching unit.

11. The antenna according to claim 10, wherein the matching unit comprises an inductor and a capacitor, the feeding point is connected to the SAR control chip through an inductor L1, and the feeding point is connected to the radio frequency chip through a capacitor C1 and an impedance adjustment unit.

12. The antenna according to claim 2, wherein a width of the gap ranges from 0.2 mm to 1.2 mm.

13. A mobile terminal, comprising the antenna for a mobile terminal according to claim 1.
